(19) United States
(12) Patent Application Publication
(10) Pub. No.: US 2002/0143784 A1
(43) Pub. Date: Oct. 3, 2002

(54) Method and system for application behavior analysis

(75) Inventor: Harm Sluiman, Scarborough (CA)

Correspondence Address: Gregory M. Doudnikoff, IBM Corporation T81/503, PO Box 12195, Research Triangle Park, NC, 27709, US

(73) Assignee: International Business Machines Corporation, Armonk, NY (US)

(21) Appl. No.: 10/098,185

(22) Filed: Mar. 14, 2002

(30) Foreign Application Priority Data
Mar. 14, 2001 (CA) 2340824

(51) Int. Cl. G06F 7/00

(52) U.S. Cl. 707/100

(57) ABSTRACT

Embodiments of the invention provide data structures or objects for use by application behavior analysis tools. The data structures or objects are used to store data pertaining to behavior of an executed application, events, and input and output collected during execution of an application. Consequently, data collected by one application analysis tool may be stored in the data structures. These populated data structures may then be used by other application analysis tools without having to re-execute the application and re-collect the data. Such embodiments reduce the required number of executions of a particular scenario being analyzed. Additionally, data collected and stored in the common data structures during a single execution may be analyzed in various ways by suitable analysis tools available. This may enable defects which are not identifiable using a particular analysis tool from a first vendor to be identified using a different analysis tool from a second vendor without the need to re-run or re-execute the scenario.

### BACKGROUND OF THE INVENTION

1. Field of the Invention

The present invention relates to the analysis of computer applications and, more particularly, to a method and system for analysis application behavior.

2. Description of the Related Art

The development of computer applications continues to increase in complexity.

Complexity in recently developed applications often arises, in the business and corporate and environments, from increased use and reliance on distributed networks, such as the public Internet and private intranets. In such environments, robust and reliable applications are critical.

Teams that develop applications often must integrate disparate hardware and software subsystems so that each subsystem will communicate, cooperate and handle increased processing loads all the while meeting or exceeding increasingly strict overall system “up-time” requirements. These requirements have increased the complexity and pressure experienced in the application development environment.

In addition to the complexity and pressures, the application development environment has changed dramatically during the past decades. In the not too distant past, it was relatively common for a single developer or programmer to design, code and test a significant portion of an application. For sophisticated applications, this is simply not the case anymore. Today, a team of application architects designs a particular feature for a much larger application. The design details are forwarded to a team of programmers or coders to implement. The implemented design feature is then forwarded to a debug and test team to identify and resolve any defects in the implemented feature. Moreover, these teams do not operate in a serial fashion, but rather in a collaborative and often parallel manner. As will be appreciated, the logistics required to manage such a development team is significant, especially when there is a market delivery deadline which must be satisfied.

In the past, a developer or development team would often use development tools (e.g., rapid application development tools, compilers, objects, debuggers, etc.) from a single source or vendor. Unfortunately, the present development environment, due to the pressures, complexity and disparate hardware and software environments of potential users of an application, often requires a development team to select tools from many different vendors. This use of development tools from a multitude of vendors is often the result of the inability of single vendor to support all of the platforms with which applications are presently being required to interact.

The proliferation of development tools from various vendors has also exacerbated the complexity in application development in another manner. Notably, application development tools designed to provide analysis of application behavior require significant execution time. Unfortunately, due to the numerous behaviors and interactions which require analysis in a complex application (which may include numerous sub-components), many different tools from many different vendors are often required by a development team. While this has resulted in excellent analysis of an application, it often is extremely time consuming and reduces the time available to the development team to rectify any behavioral difficulties encountered.

Due to the proliferation of tools which are, typically, focussed on the analysis of very specific behavior, interactions between tools is extremely limited and difficult to implement. For a specific analysis tool from a first vendor to interact with “n” tools from other vendors often requires that the first vendor to develop “n” communication interfaces. This required development is costly, time consuming and, often, would not be implemented by vendors of tools due, generally, to the rapidly changing environment of application development environments and, more specifically, to a general lack of resources (e.g., time, money, personnel, etc.).

Additionally, despite the increased use and reliance on distributed applications and environments (i.e., an application or portions thereof which are distributed amongst several computer systems), the development tools to analyze the behavior of distributed applications is lacking. Take, for example, an electronic commerce application which includes a user interface provided through a web page provided via a web server (a first computer system) that requests and transmits data, using a data network, to numerous other computer systems (e.g., a customer relationship database, a order processing system, a shipping system, etc.). In this example, developers presently tasked with analyzing the distributed application often must analyze the portions of the distributed application executing on the various computer systems separately. This is both costly, time consuming and, often, produces unsatisfactory or unreliable analysis of the application under development.

As such, improvements in the field of application behavior analysis are desired.

### SUMMARY OF THE INVENTION

Embodiments of the invention provide data structures or objects for use by application behavior analysis tools. The data structures are used to store data corresponding to behaviors displayed by the development application which is collected during execution of the application. Consequently, data collected may be used by one or more application behavior analysis tools. Such embodiments advantageously reduce the required number of executions of an application under development for the requisite analysis.

Additionally, data collected and stored in the data structures during a single execution may be analyzed by suitable behavior analysis tools. Consequently and advantageously, defects which might not be identifiable using a first analysis tool may be identified using a second analysis tool without the need to re-run or re-execute the application. This “run once analyze many times” environment provides increased time to analyze the behavior data (cf. present systems in which significant time is spent collecting behavior data which requires, for each analysis tool, execution of the application under development), improved analysis and a considerable time savings to identify defects and generate fixes.

Embodiments of the invention may stored the data structures as objects in a database.

Data collected describing the behavior of an application may then be stored in instances of the objects in the database. The database storing the behavior may then be accessed by a plurality of analysis tools produced by a plurality of tool vendors. Such an accessible database (or other data repository), which may be populated with behavior data from one or more event logging applications, enables the “run once analyze many times” paradigm to be realized.

Embodiments of the invention provide an environment wherein an event logger (which collects data describing the behavior of an application) is separated from a tool which performs the analysis on the collected behavior data. This separation enables a developer to select and use an event logger (or a plurality of event loggers) which can satisfactorily provide the behavior data required by the developer. (An event logger may be suited to a particular type of application, a selected deployment environment, collecting data describing particular behaviors and the like.) Additionally, embodiments of the invention also enable a developer to select and use an analysis tool (or a plurality of analysis tools) which can satisfactorily provide the analysis of the behavior data collected. As a consequence, embodiments of the invention provide a separation between the event logger portion and the analyzing portion. As such, a developer is no longer beholden or restricted to using a single tool from a single vendor which combines event logging functionality (which may be unsatisfactory or unsuitable for some reason) and an analysis tool portion (which may be unsatisfactory or unsuitable). Embodiments of the present invention allow a developer to “mix and match” the most suitable event logger(s) with the most suitable analysis tools for the application and its environment.

Embodiments of the invention may implement the data structures using the Unified Modeling Language (UML) available from the Object Management Group, Inc. (OMG) of Needham, Mass., USA. Version 1.3 of UML was published by OMG in March, 2000—the contents of which are hereby incorporated herein by reference.

Embodiments of the invention may reflect contextual information about applications being analyzed.

Advantageously, embodiments of the invention reduce the burden on the vendor of a first analysis tool as the need to develop specific communication interfaces to enable communication between the first vendor's tools and other vendors' tools is reduced.

Embodiments of the invention may exchange data in a serialized manner through use of the Meta-Object Facility (MOF) (described in a specification of the same name) and the Extensible Markup Language (XML) Metadata Interchange (XMI) (also described in a specification of the same name). Both the MOF and XMI specifications are available from OMG, the contents of each of which are hereby incorporated herein by reference. The UML, XMI and MOF specifications can be obtained from the web site of OMG located at http://www.omg.com.

In one aspect of the invention there is provided a computer system providing application analysis comprising: a database for storing data; an event logger storing data corresponding to behavior of an executing application in said database; and wherein, responsive to a request received from a first application analysis tool, said database transmitting a first portion of said data stored in said database to said first application analysis tool, and wherein, responsive to a request received from a second application analysis tool, said database transmitting a second portion of said data stored in said database to said second application analysis tool.

In a further aspect of the invention there is provided a method for analyzing the behavior of an application comprising: storing behavior data corresponding to behavior of said application during exhibited execution in a database, a first analysis tool analyzing a first portion of said behavior data stored in said database; and a second analysis tool analyzing a second portion of said behavior data stored in said database.

In a further aspect of the invention there is provided a database for storing behavior data describing behavior of an application, said database comprising: a receiver receiving data requests, said data requests comprising at least one of: a data request to store behavior data describing behavior of an application and a request for behavior data stored by said database; and wherein behavior data forming part of a data request to store behavior data is stored by said database, and wherein said receiver is adapted to receive data requests for behavior data from a plurality of analysis tools; said data requests further comprising a request for behavior data stored by said database; and a transmitter, said transmitter, responsive to a data request comprising a request for behavior data, transmitting said requested data.

In a further aspect of the invention there is provided a computer readable media storing computer readable instructions and data, said instructions and data adapting a computer system to: store behavior data corresponding to behavior describing execution of an application in a database, analyze a first portion of said behavior data stored in said database using a first analysis tool; and analyze a second portion of said behavior data stored in said database using a second analysis tool.

### BRIEF DESCRIPTION OF THE DRAWINGS

FIG. 1 schematically illustrates a computer system embodying aspects of the invention;

FIG. 2 schematically illustrates, in greater detail, a portion of the computer system of FIG. 1;

FIG. 3 illustrates, in functional block form, a portion of FIG. 2;

FIG. 4 is a flowchart of exemplary operations of the computer system of FIG. 1;

FIG. 5A is schematic illustration of a first exemplary object class modeling particular behaviors of an exemplary application;

FIG. 5B are tables describing a first object of the object class of FIG. 5A;

FIG. 5C are tables describing a second object of the object class of FIG. 5A;

FIG. 5D are tables describing a third object of the object class of FIG. 5A;

FIG. 5E are tables describing a fourth object of the object class of FIG. 5A;

FIG. 5F are tables describing a first field of the object of FIG. 5E;

FIG. 5G are tables describing a second field of the object of FIG. 5E;

FIG. 5H are tables describing a third field of the object of FIG. 5E;

FIG. 5I are tables describing a fourth field of the object of FIG. 5E;

FIG. 5J are tables describing a fifth field of the object of FIG. 5E;

FIG. 5K are tables describing a sixth field of the object of FIG. 5E;

FIG. 5L are tables describing a seventh field of the object of FIG. 5E;

FIG. 5M are tables describing the object class of FIG. 5A;

FIG. 6A is schematic illustration of a second exemplary object class modeling particular behaviors of an exemplary application;

FIG. 7A are tables describing a first object of the object class of FIG. 6A;

FIG. 7B are tables describing a second object of the object class of FIG. 6A;

FIG. 7C are tables describing a third object of the object class of FIG. 6A;

FIG. 7D are tables describing a fourth object of the object class of FIG. 6A;

FIG. 7E are tables describing a fifth object of the object class of FIG. 6A;

FIG. 7F are tables describing a sixth object of the object class of FIG. 6A;

FIG. 7G are tables describing a seventh object of the object class of FIG. 6A;

FIG. 7H are tables describing a eighth object of the object class of FIG. 6A;

FIG. 8 schematically illustrates a networked computer system embodying additional aspects of the invention;

FIGS. 9A and 9B illustrate, in functional block form, portions of the computer systems forming part of FIG. 8; and

FIG. 10 is flowchart of exemplary operations of the networked computer system of FIG. 8.

### DESCRIPTION OF THE PREFERRED EMBODIMENT

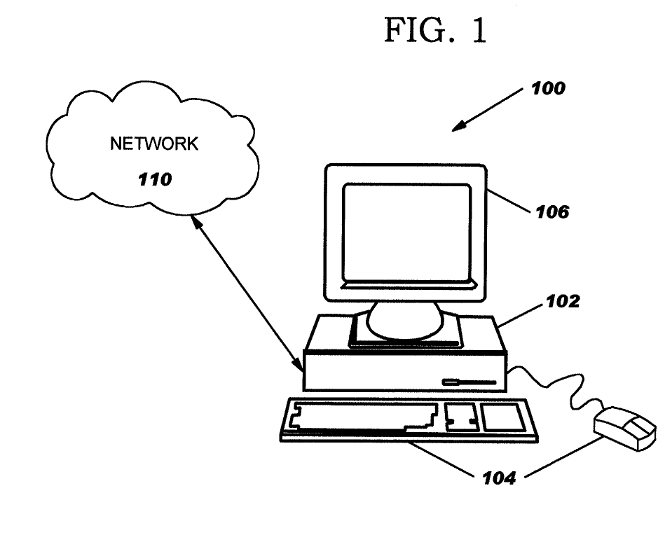

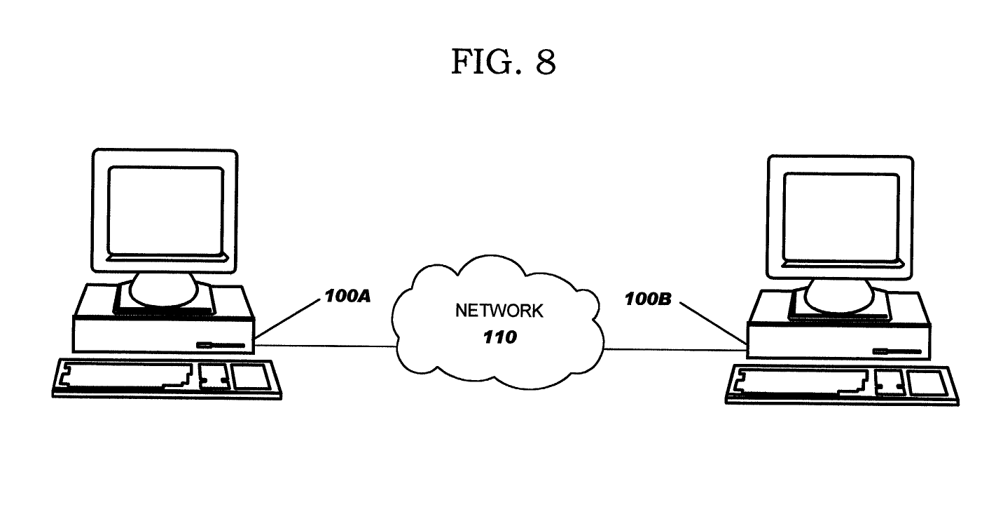

An embodiment of the invention, computer system 100, is illustrated in FIG. 1. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like. As is discussed with reference to FIG. 8, computer system 100 may interact with other networked computer systems (not shown) providing application analysis of a distributed application.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing system 102 which communicates with various input devices 104, output devices 106 and network 110. Input devices 104, two of which are shown, may include, for example, a keyboard, a mouse, a scanner, an imaging system (e.g., a camera, etc.) or the like. Similarly, output devices 106 (only one of which is illustrated) may include displays, information display unit printers and the like. Additionally, combination input/output (I/O) devices may also be in communication with processing system 102. Examples of conventional I/O devices include removable and fixed recordable media (e.g., floppy disk drives, tape drives, CD-ROM drives, DVD-RW drives, etc.), touch screen displays and the like.

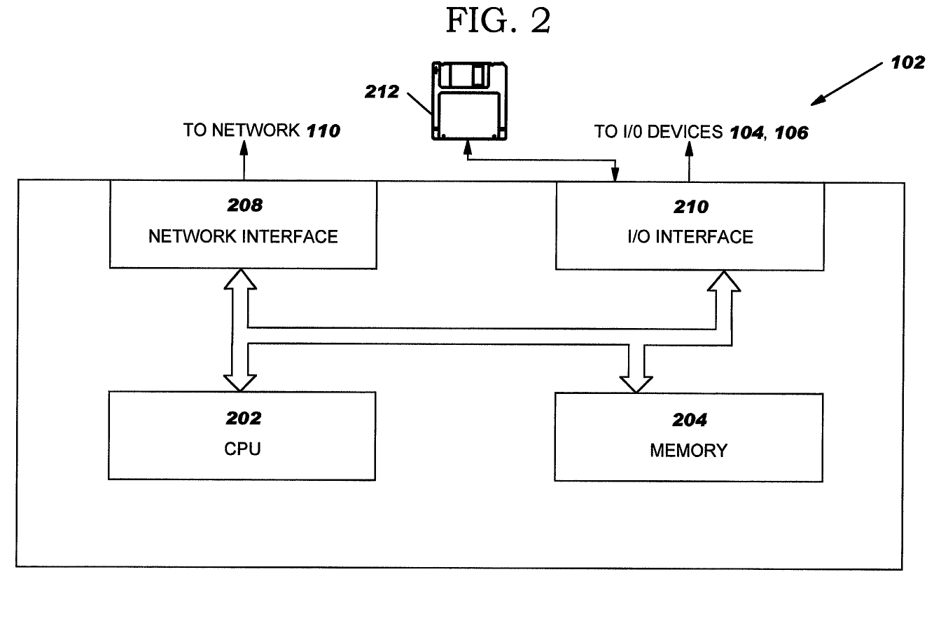

Exemplary processing system 102 is illustrated in greater detail in FIG. 2. As illustrated, processing system 102 includes several components, including central processing unit (CPU) 202, memory 204, network interface (I/F) 208 and I/O I/F 210. Each component is in communication with the other components via a suitable communications bus 206 as required.

CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 102 could use alternative CPUs and may include embodiments in which one or more CPUs are employed. CPU 202 may include various support circuits to enable communication between itself and the other components of processing system 102.

Memory 204 includes both volatile and persistent memory for the storage of: operational instructions for execution by CPU 202, data registers, application storage and the like. Memory 204 preferably includes a combination of random access memory (RAM), read only memory (ROM) and persistent memory such as that provided by a hard disk drive.

Network I/F 208 enables communication between computer system 100 and other network computing devices (not shown) via network 110. Network I/F 208 may be embodied in one or more conventional communication devices. Examples of a conventional communication device include an Ethernet card, a token ring card, a modem or the like. Network I/F 208 may also enable the retrieval or transmission of instructions for execution by CPU 202 from or to a remote storage media or device via network 110.

I/O I/F 210 enables communication between processing system 102 and the various I/O devices 104, 106. I/O I/F 210 may include, for example, a video card for interfacing with an external display such as output device 106. Additionally, I/O I/F 210 may enable communication between processing system 102 and a removable media 212. Although removable media 212 is illustrated as a conventional diskette other removable memory devices such as Zip™ drives, flash cards, CD-ROMs, static memory devices and the like may also be employed. Removable media 212 may be used to provide instructions for execution by CPU 202 or as a removable data storage device. Zip is a trademark of the Iomega Corporation.

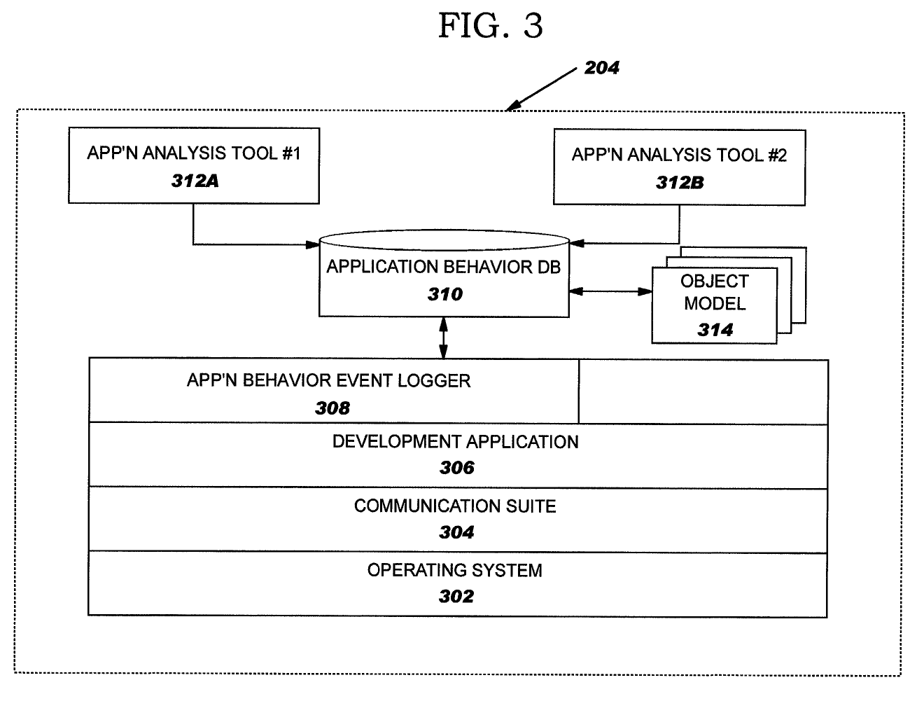

The computer instructions/applications stored in memory 204 and executed by CPU 202 (thus adapting the operation of computer system 100 as described herein) are illustrated in functional block form in FIG. 3. As will be appreciated by those of ordinary skill in the art, the delineation between aspects of the applications illustrated as functional blocks in FIG. 3 is somewhat arbitrary as the various operations attributed to a particular application as described herein may, in alternative embodiments, be subsumed by another application.

As illustrated, for exemplary purposes only, memory 202 stores operating system (OS) 302, communications suite 304, development application 306, application behavior event and data logger 308, database 310 (storing data corresponding to the behavior of development application 306 and object model 314) and two application analysis tools 312A and 312B.

OS 302 is an operating system suitable for operation with a selected CPU 202 and the operations described herein. Multitasking, multithreaded OSes such as, for example, IBM AIX™, Microsoft Windows NT™, Linux or the like, are expected in many embodiments to be preferred.

Communication suite 304 provides, through, interaction with OS 302 and network I/F 208 (FIG. 2), suitable communication protocols to enable communication with other networked computing devices via network 110 (FIG. 1). Communication suite 304 may include one or more of such protocols such as TCP/IP, ethernet, token ring and the like.

Development application 306 is an application (or portion or component thereof) under development which requires analysis of its execution behaviors and interactions with data or other applications (or components thereof). Development application 306 may be comprised of several sub-components such as, for example, various tools, features, servlets, etc.

As will be appreciated, development application 306 may be an application which is capable of executing as a self-contained program, an applet (e.g., requiring a JAVA™ virtual machine or the like), an application executing through an intermediary such as, for example, an integrated development environment such as that provided by IBM VisualAge™, in debug mode or in other manners (e.g., within an application server, as part of database of stored procedures, user-defined functions or triggers, etc.). In such scenarios, execution characteristics, sometimes referred to as execution context, are often relevant and pertinent to the analysis of the behavior of development application 306. Context data, for distributed applications, may include data which describes or identifies the computer system upon which the distributed portions of the distributed application are executing. If development application 306 is not a self-contained program, but requires the operation of other applications then these other applications (not shown) may also be stored in memory 204 and executed by processor 202 (or may be stored and/or executed on another networked computer device). Java is a trademark of Sun Microsystems, Inc.; VisualAge is a trademark of the IBM Corp.

While application 306 is described as “under development”, it is to be understood that the invention described herein is equally applicable to assist in the analysis of developed applications. However, as is often the case, application analysis would be most likely deployed in the development environment.

Application behavior event logger 308 operates to track (i.e., identify and record) the events, behaviors and context (collectively referred to herein as “behaviors”) of development application 306 during execution. Event loggers 308 are sometimes referred to as “probes” or “instrumentation ”. For example, Aprobe™ is produced by OCSystems Inc. of Fairfax, Va., USA is one example of an event logger. The specific operations of event logger 308 are described in greater detail below.

The data tracked by application behavior event logger 308 is stored in application behavior database 310. Input and output data provided to and generated by development application 306 may also be tracked by event logger 308 and stored in database 310. Data stored in database 310 is then be used to populate an object model of the application (described in greater detail below) which can be accessed and used by behavior analysis tools 312A, 312B. Database 310 may be implemented using, for example, a structured query language (SQL) compliant database such UDB DB2™ available from IBM Corporation. Database 310 is adapted to receive, through a receiver function, data requests. These data requests may include, for example, requests to store behavior data in database 310 or requests for behavior data from a behavior analysis tool 312. These requests may be in the form, for example, of an SQL compliant message. In response to a received request for behavior data, database 310 is further adapted to retrieve the requested data stored by database 310 and then transmit the retrieved data, through a transmitter function, to the requesting party (e.g., an analysis tool 312). DB2 is a trademark of the IBM Corp.

Also stored by application behavior database 310 is development application object model 314. Object model 314 provides a structure or template of behaviors which may be displayed during execution of application 306. Object model 314 provides a convenient mechanism in which data describing the behavior of application 306 can be organized. Object model 314 may be created using UML. UML is a graphical language for visualizing, specifying, constructing and documenting the artifacts of a software-intensive system.

Object model 314 models the behaviors of, and interactions between, the sub-components (e.g., objects, functions, procedures, servlets, tools, etc.) of development application 306. The behaviors between development application 306 and other applications or objects are also tracked (e.g., the interaction with an Enterprise Information System (EIS), an external database, a web server, etc.). As will be appreciated other modeling languages could be employed in alternative embodiments to create object model 314. Additionally, use of structured model (rather than an object oriented model) could also be employed.

The structure of object model 314 is determined in part by operating system 302 (e.g., whether the OS supports multithreading, whether distributed applications are supported, etc.), the hardware of computing system 100 (e.g., the types of behaviors that can be generated by the hardware—mouse clicks, hardware interrupts, etc.), the language used (e.g., JAVA™, C++, etc.) and development application 306. Behaviors displayed by application 306, and thus identified by event logger 308, will result in instances of the objects being populated by event logger 308 and stored in database 310. Data stored in instances of object model 314 include data relating to processes performed, threads, nodes, methods invoked and the like.

Also, stored within memory 204 is first and second application analysis tools 312A, 312B respectively (individually and collectively referenced as analysis tool(s) 312). Analysis tools 312 may be conventional tools such as, for example, those available from Performance Analyzer™ from IBM Corporation and Rational Purify™ from Rational Software Corporation, which have been suitably modified to perform the operations described herein.

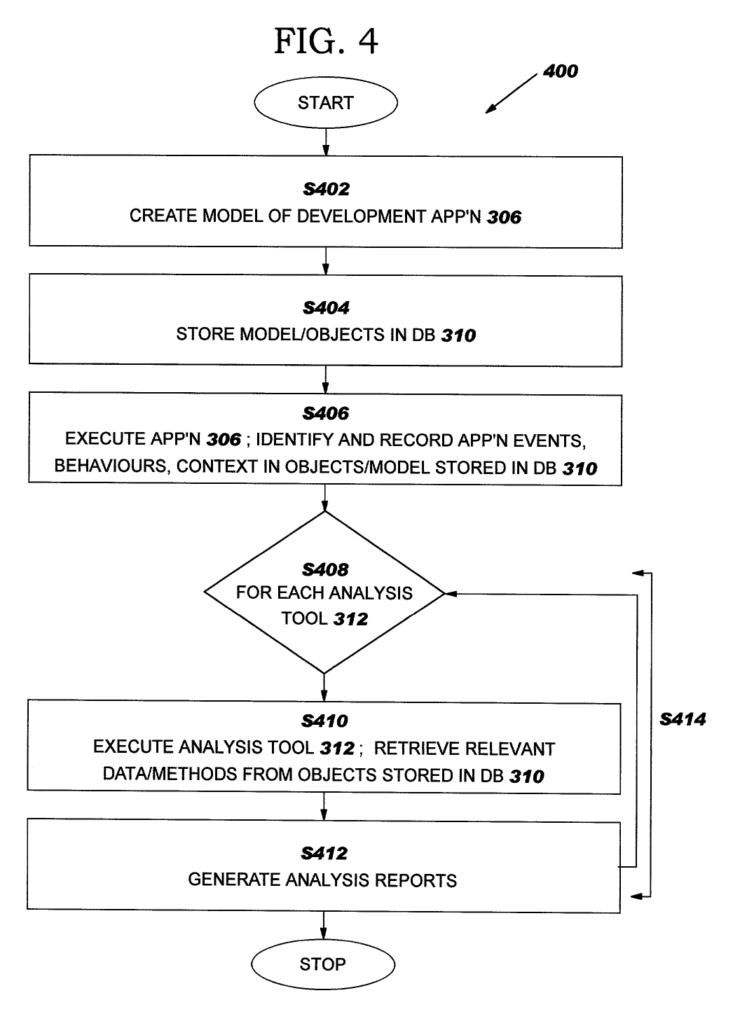

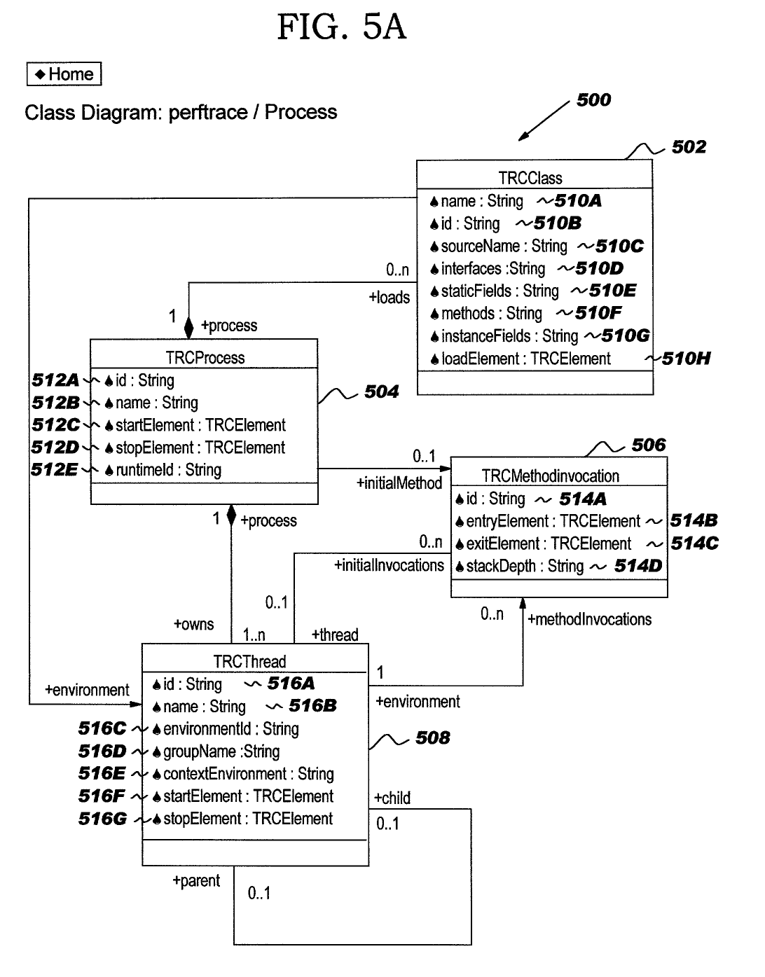

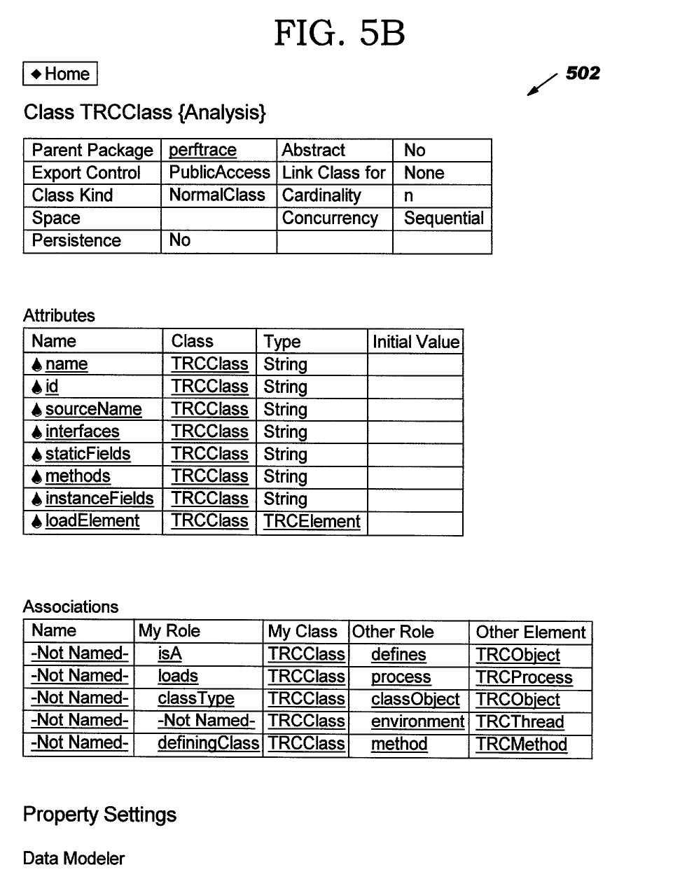

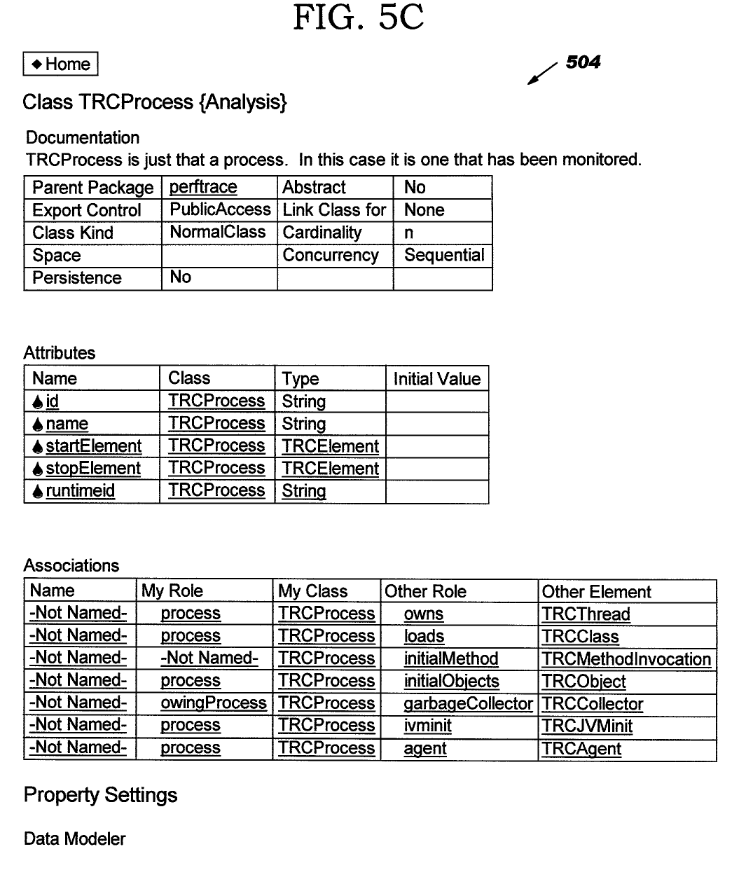

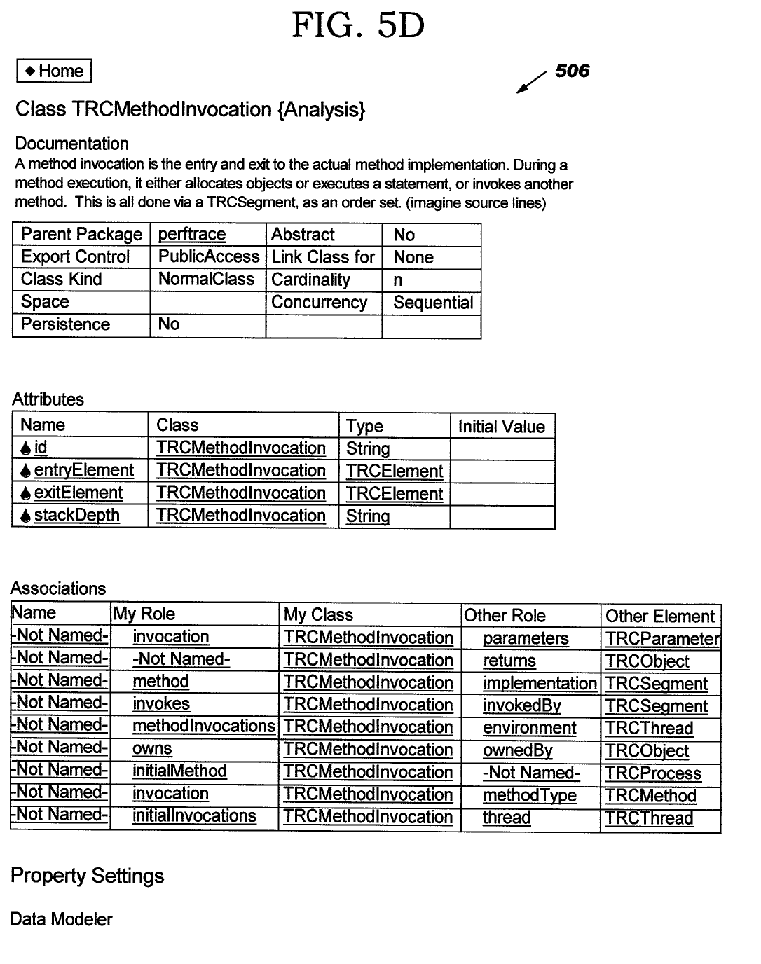

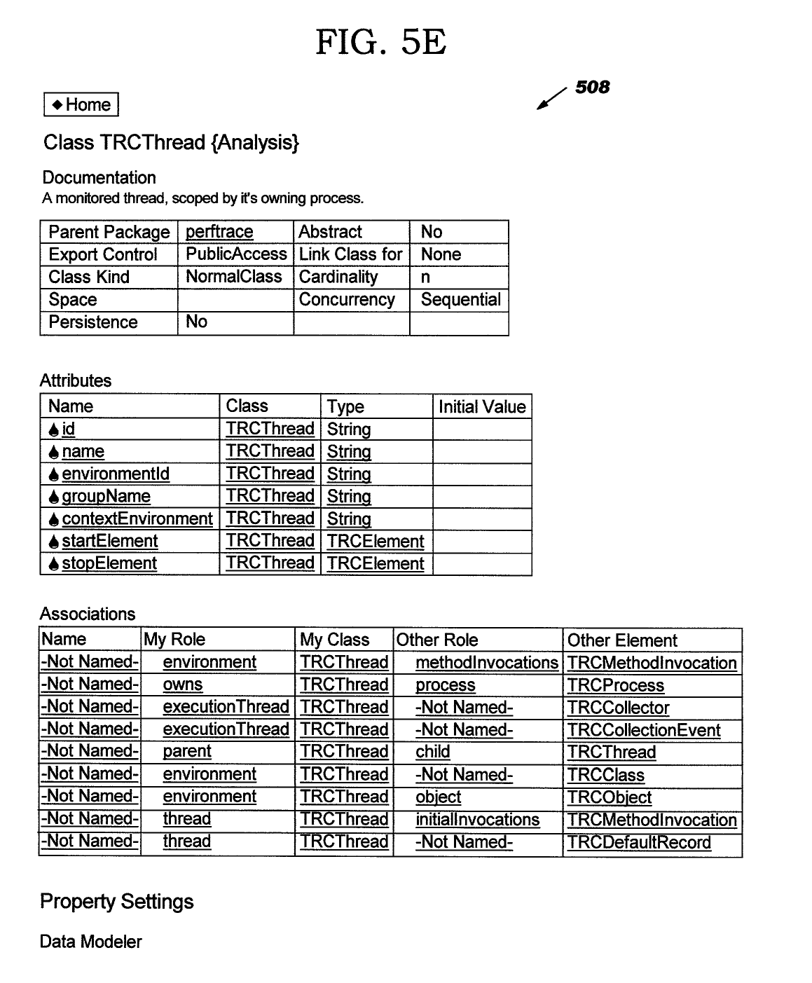

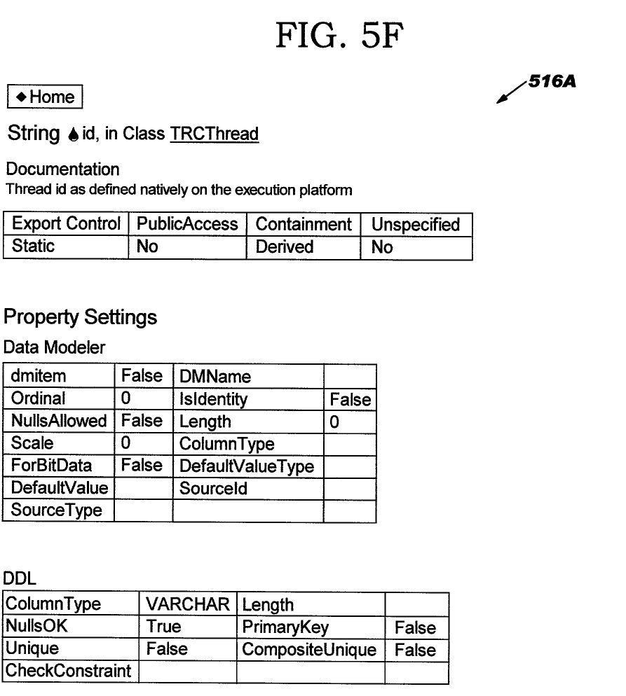

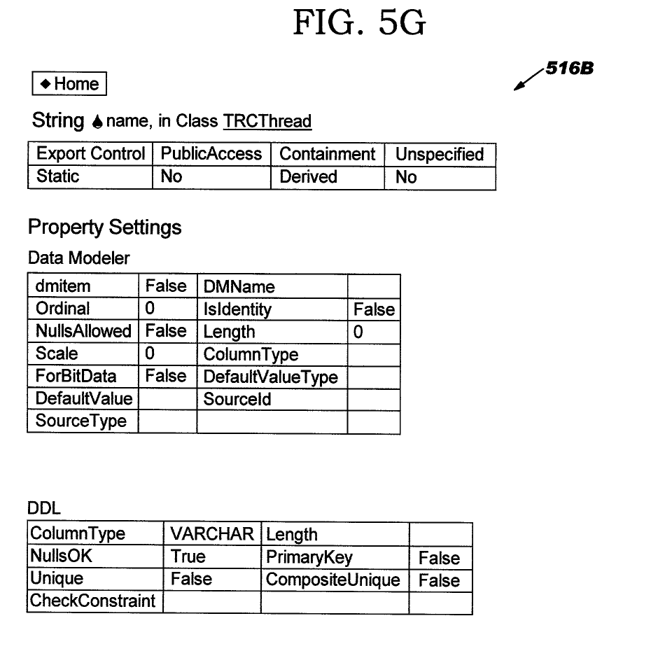

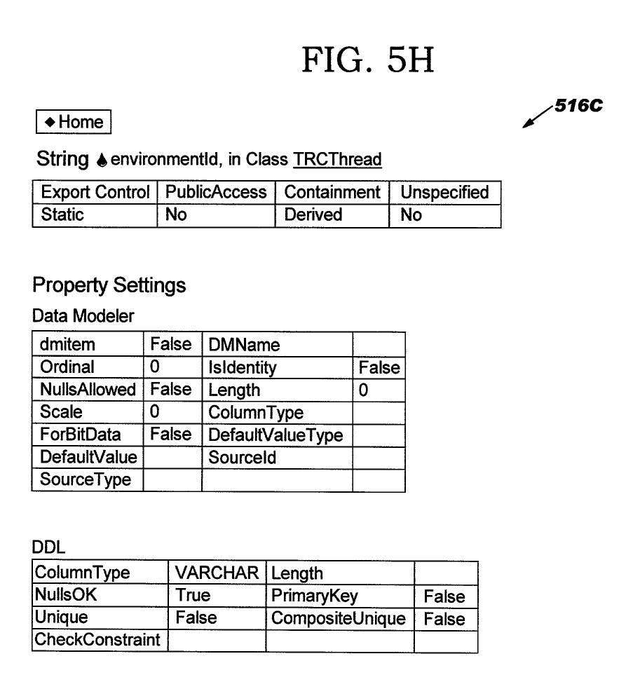

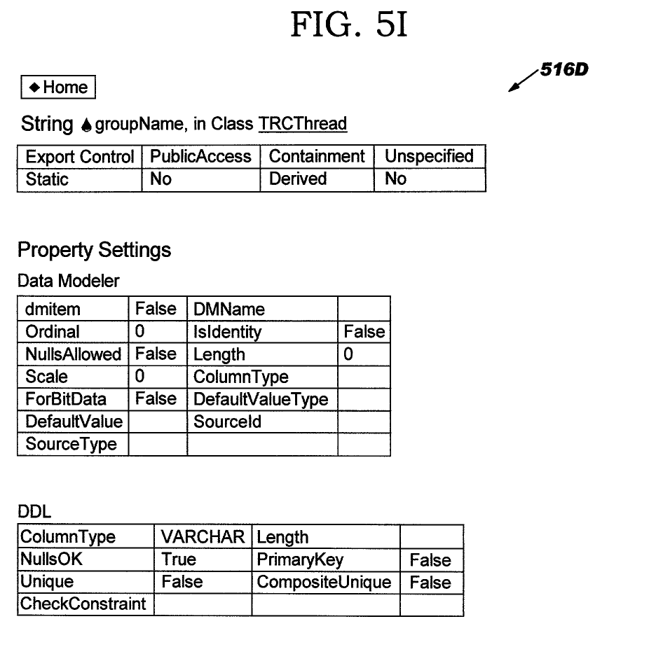

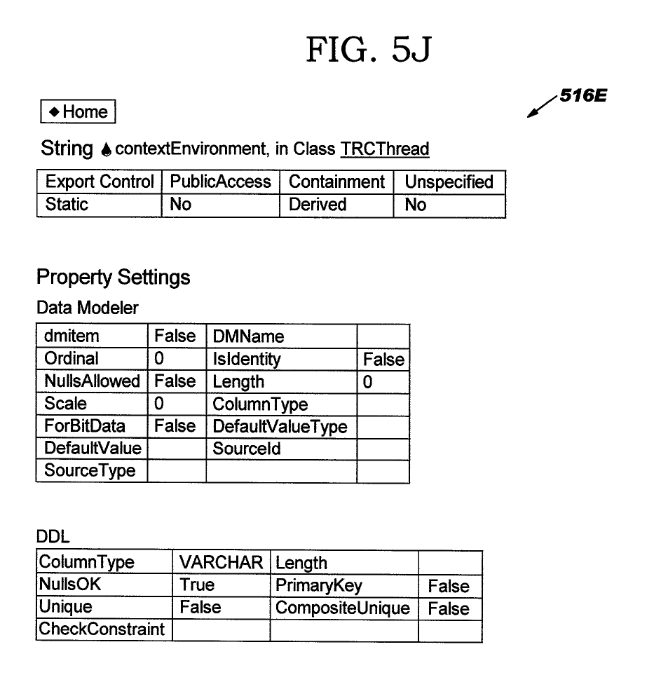

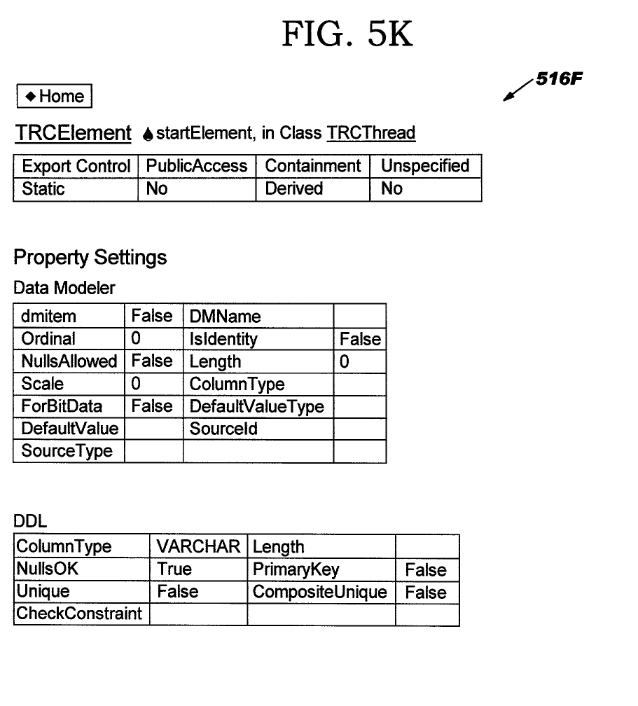

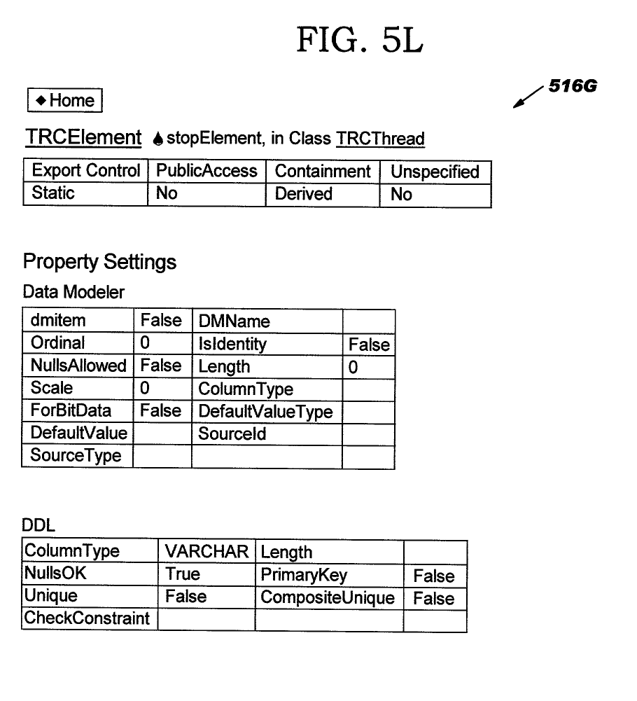

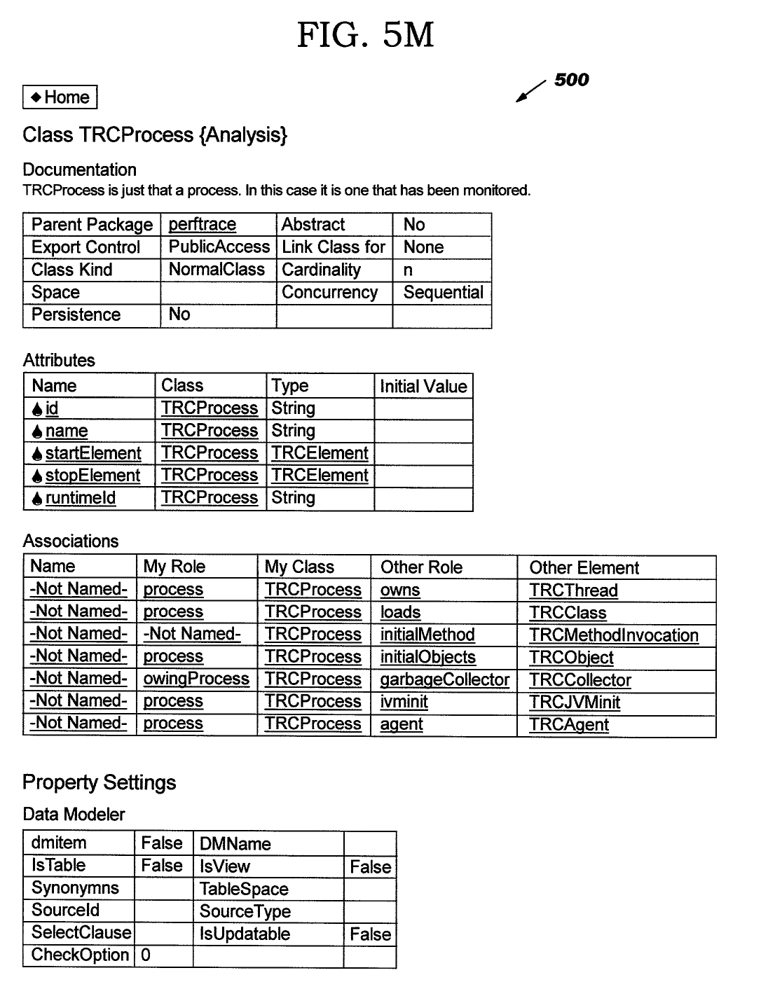

The operations of the exemplary computer system 100 is described in greater detail with reference to FIGS. 4-7. FIG. 4 provides a general overview of the operations of computer system 100 depicted as operations 400. FIGS. 5-7 provide additional detail of exemplary objects involved and the data collected and analyzed during performance of operations 400.

Initially, an object model 314 of development application 306 is created or retrieved and stored within database 310 (S402, S404, respectively). As an object model of a development application is often created as part of the initial design and development stages, it may be preferable and more convenient to use this model for the analysis of the behavior of development application 306.

Once an object model 314 has been created (or retrieved) and stored in database 310, development application 306 is executed in a conventional manner (e.g., independently or through use of intermediary applications such as, for example, an integrated development environment or debugger) (S406). Additionally, application behavior event logger 308 is simultaneously (or, preferably, before execution of application 306) executed to capture and log the behavior of application 306.

As described above in general terms, event logger 308 identifies behaviors displayed by development application 306. Behaviors such as user input data streams to and output data streams from development application 306, interface events, memory reads/writes, loading/unloading of dynamically linked libraries, method invokations, process launches, spawning of threads, etc. are identified by event logger 308 and the data relating to these behaviors is stored in a unit of memory (which, in the exemplary embodiment, is conveniently formatted as an object) that corresponds to the particular behavior identified. For example, in S402, a user interface (UI) mouse trigger object of object model 314 may be created to correspond to receipt of mouse trigger behaviors generated by a user's interaction with development application 306. An instance of the UI mouse trigger object is populated with data corresponding to the user's mouse trigger. This data may include, for example, the type of user selectable items presented to the user (e.g., radio button objects, drop down box objects, etc.), the data contained within the user selectable objects (e.g., the choices of radio button/drop down list objects, the default state of the radio button/drop list objects, etc.), the item selected (e.g., a radio button, an item in a drop down list, etc.), the context of the UI presented to the user (e.g., whether the item was presented as a result of an error). Other data may also be collected such as, for example, the input data stream presented to development application 306, the output data stream generated by application 306 and the like. As will be appreciated by those of ordinary skill in the art, the data identified by event logger 308 depends in part on the objects contained with object model 314, the data of relevance to the analysis tool, development application 306, the behavior of other applications with which development application 306 interacts, the operating system 302 of computer system 100, the input and output devices 104, 106, the network environment, the context in which development application is being executed as well as many others.

Event logger 308 may, in alternative embodiments, simply generate and output a data stream corresponding to the behaviors identified. This data stream may, in these alternative embodiments, be parsed and organized by a separate application designed for this task or be parsed and organized by database 310.

Once the behaviors relating to the execution of development application 306 have been identified and stored in instances of objects forming part of object 314 (and, thus stored within database 310), one or more application analysis tools 312 are then executed to generate any required analysis reports (operations S414) by accessing the data stored in instances of the objects of object model 314 which are stored database 310. As will be apparent, the execution of more than one application analysis tools 312 does not necessarily require the re-execution of application 306 since the data required by analysis tools 312 will have been stored by event logger 308 in database 310. This ability advantageously enables application 306 to be executed or run once while analyses of behavior data may be run many times. As will be appreciated by those of ordinary skill in the art, after analysis of the behavior data has been completed, defects or bugs may be identified by the development team. Development application 306, after correction of the defects identified, may then be re-executed, and behavior analysis conducted on behavior data collected during re-execution.

It should be noted that event logger 308 is described as tracking data pertaining to all behaviors occurring and the complete behavior of application 306. As will be appreciated, it may be desirable in some instances to use more focussed or less generic event loggers (i.e., event loggers that do not track all behaviors). In such embodiments, a particular application analysis tool 312 may require data that was not tracked by such an event logger. In this instance, an application analysis tool 312 may not be able to generate all of the reports required. However, embodiments of the invention may include use of more than one event logger 308 running in parallel or serially. In these latter embodiments, event loggers 308 would store data relating to behaviors such that the cumulative amount of data collected by the plurality of event loggers would be available for analysis by one or more analysis tools 312. For example, two event loggers 308 may store data relating to the behavior of development application 306 in a single database 310 (which is accessible to one or more analysis tools).

During operations S414, each application analysis tool 312 is executed (either serially or in parallel). During execution, an application analysis tool 312 accesses or retrieves the data (or a copy of the data) stored by database 310 in object model 314. Using the data retrieved (or copied), analysis tool 312 performs a requested analysis on the logged behavior data (S410). Analysis tool 312 may then issue a requested behavior analysis report (S412). While the execution of analysis tools 312 is shown as being executed sequentially (i.e., in series), it is envisioned that two or more application analysis tools 312 may be executed simultaneously (i.e., in parallel). This will enable increased efficiency and productivity during development of application 306.

In an alternative embodiment, a single analysis tool 312 may be executed in step S406 to populate the objects (i.e., set the properties of the objects) in object model 314. (The populated object organizing the behavior data collected by event logger 308.) In such an embodiment the event logger 308 would be combined with the operations of one analysis tool 312 with tracked data still being stored in database 310. However, in this embodiment, other analysis tools would be able to access the data stored in database 310 and would not, therefore, also need to be combined with an additional event logger 308.

As will be appreciated by those of ordinary skill in the art, the foregoing operations 400, which embody aspects of the invention, enable development application 306 to be executed once while enabling the analysis of the execution to be performed by several analysis tools 312. As identified above, the analysis of a single application 306 under specified conditions (a “scenario”) by more than one analysis tool has in the past required the application to be executed at least once for each analysis tool. In distinct contrast, embodiments of the present invention enable the scenario to be executed once, while enabling one or more analysis tools 312 to use the data collected during execution (“run once, analyze many times”). This aspect is often advantageous as the run-time environment may be slightly different between execution of the same scenario. As such, these slight variations in the run time environment (which may affect the analysis prepared by different analysis tools) are reduced by embodiments of the invention since different analysis tools will operate on logged data collected from a single execution of the application 306.

Additionally and advantageously, embodiments of the invention may be employed which separate the operations of event logging (performed in the exemplary embodiment by event logger 308) from the operations of the analysis tool (performed by the operations of analysis tools 312). This separation allows a user to select the most suitable event logger and the most suitable event analysis tools for the analysis required. This is in contrast to the present situation where the event logger is combined with the analysis tool which often results in a selecting a combined tool which includes a less than satisfactory event logger and a satisfactory analysis tool (or vice versa).

Illustrated in FIG. 5A is the graphical representation of a portion of object model 314. The portion of object model 314 illustrated, for exemplary purposes, was prepared using UML to model a class of objects called “Process”. The Process class 500 (tables describing the contents of this object are illustrated in FIG. 5M) contains four tracking or trace objects, instances of which are populated by event logger 308 when a Process-type event is identified. As illustrated, the objects which are aggregated in Process class 500 are TRCClass object 502 (properties of which are described in FIG. 5B), the TRCProcess object 504 (properties of which are described in FIG. 5C), TRCMethodlnvocation 506 (properties of which are described in FIG. 5D) and TRCThread 508 (properties of which are described in FIG. 5E).

Process object 500 and the other objects which together form object model 314 will be stored in database 310. During operation of event logger 308, event logger 308 may create instances of Process object 500 and populate (i.e., assign values to) some or all of the fields of objects 502-508.

As will be appreciated by those skilled in the art, the UML model representation of Process class 500 indicates that a TRCClass object 502, which has several additional properties or members: “loads”; “owns”; “initialMethod”; and “initiallnvocations”. Property “owns” is a collection of “n” TRCThread objects 508. Property “loads” is a collection of “n” TRCClass objects 502. “initiallnvocation” references up to one (i.e., zero or one) TRCMethodlnvocation object 506.

As is known to those skilled in the art, each object includes several fields. Each field may be defined as a primitive type (e.g., a string) or another object. For example, TRCClass object 502 includes eight fields 510A-510H. Similarly, TRCProcess object 504 includes five fields (512A-512E), TRCMethodInvocation object 506 includes four fields (514A-514D) and TRCThread object 508 includes seven fields (516A-516G). A detailed description of the seven fields 516A-516G of TRCThread object 508 are illustrated in FIGS. 5F-5L.

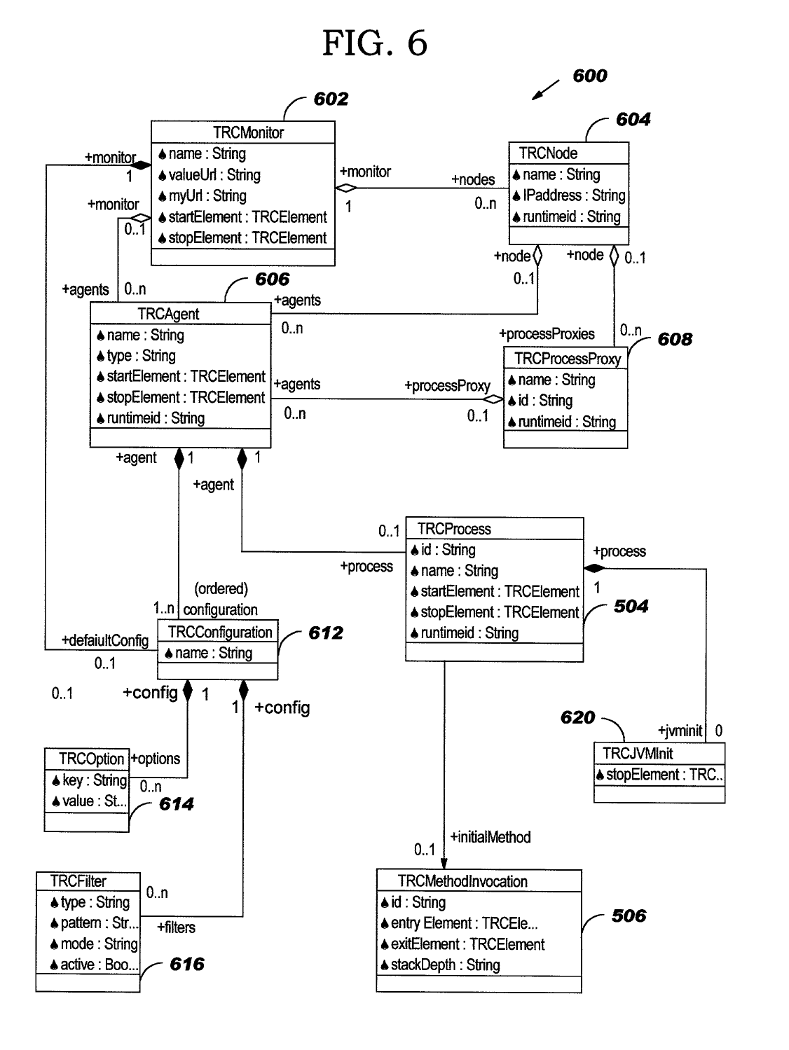

A behavior identified event logger 308 will result in event logger 308 determining to which object the event is related. That is, the event logger 308 will determine if the event identified is modeled by a Project class object 500 or other suitable objects (such as the class object and objects illustrated in FIG. 6A). If, for example, event logger 308 determines that the identified event is modeled by a Process class object 500, an instance of Process object 500 is created and stored in database 310. Instances of the various objects of Process object 500 are also created and stored in database 310 as appropriate. For example, if the process event identified (which resulted in the creation of an instance of a Process object 500) spawns a thread, an instance of TRCThread object 508 will be created by event logger 308, data which describes the thread will be collected by event logger 308 which is used to assign values to one or more of fields 516. The populated object (or a representation thereof) will then be stored in database 310 by event logger 308.

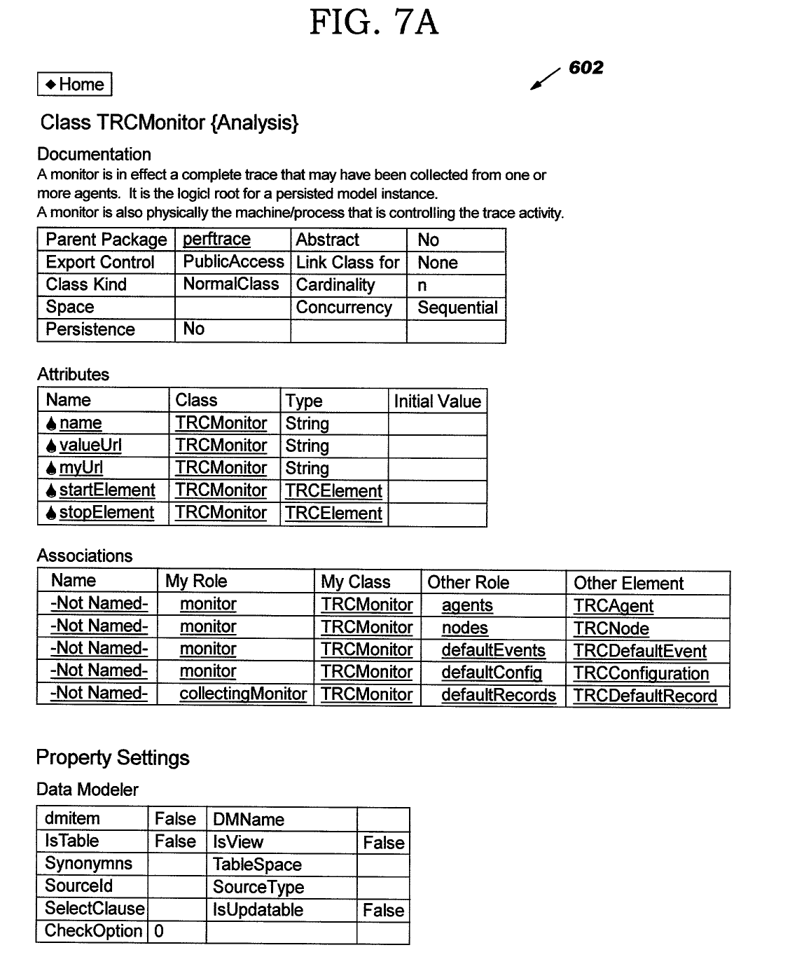

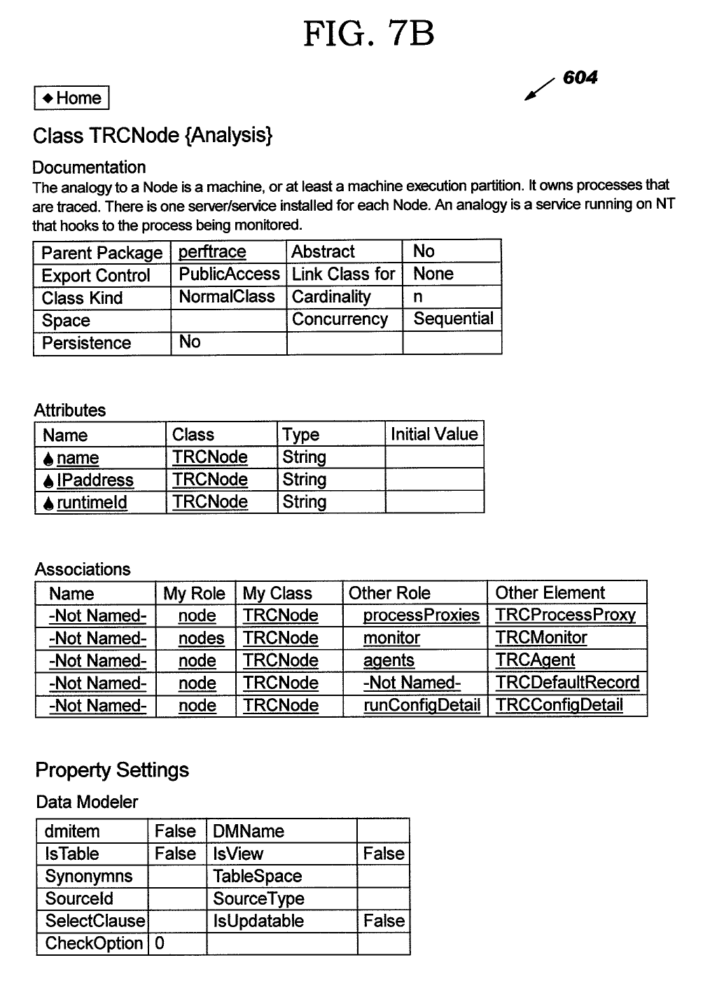

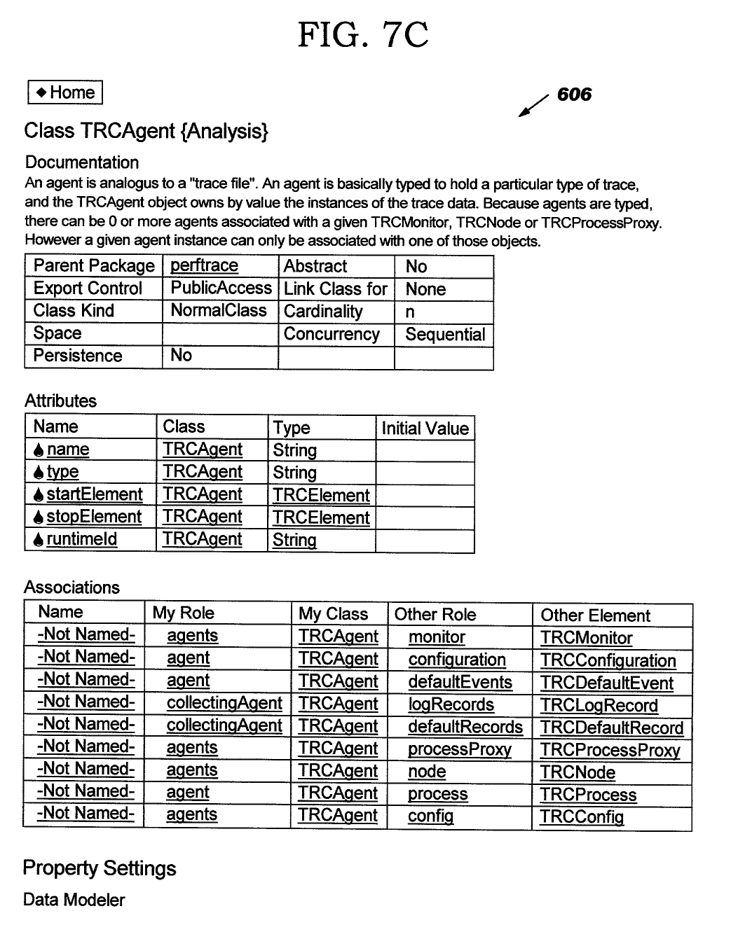

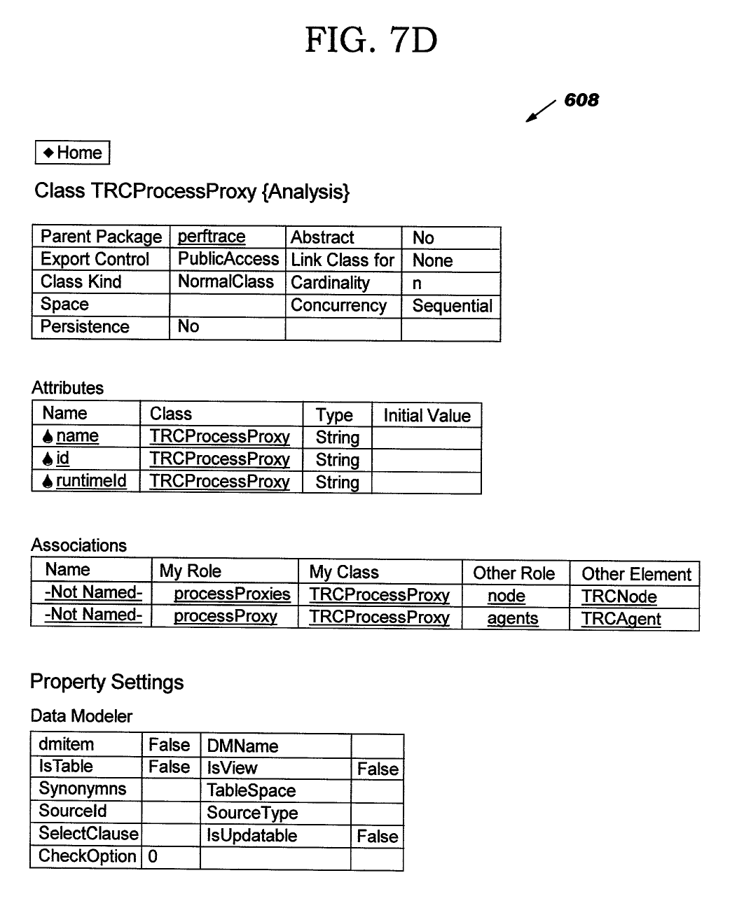

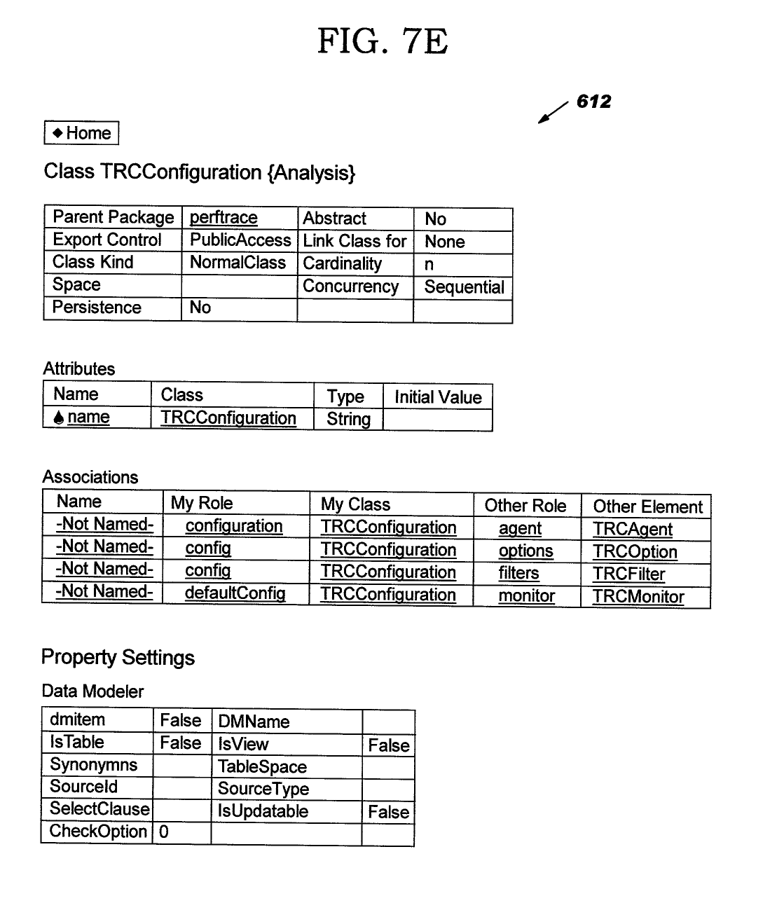

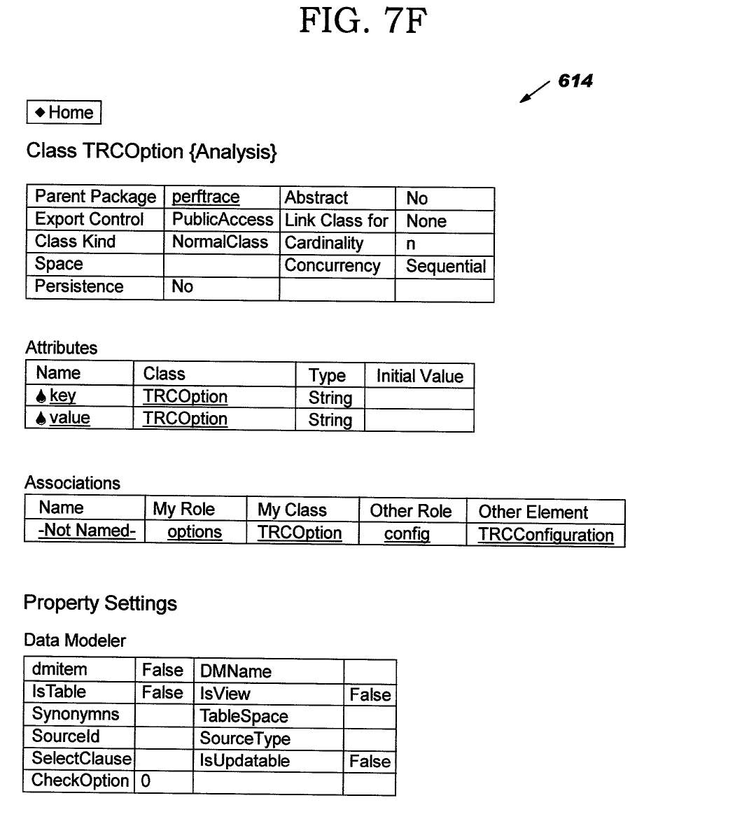

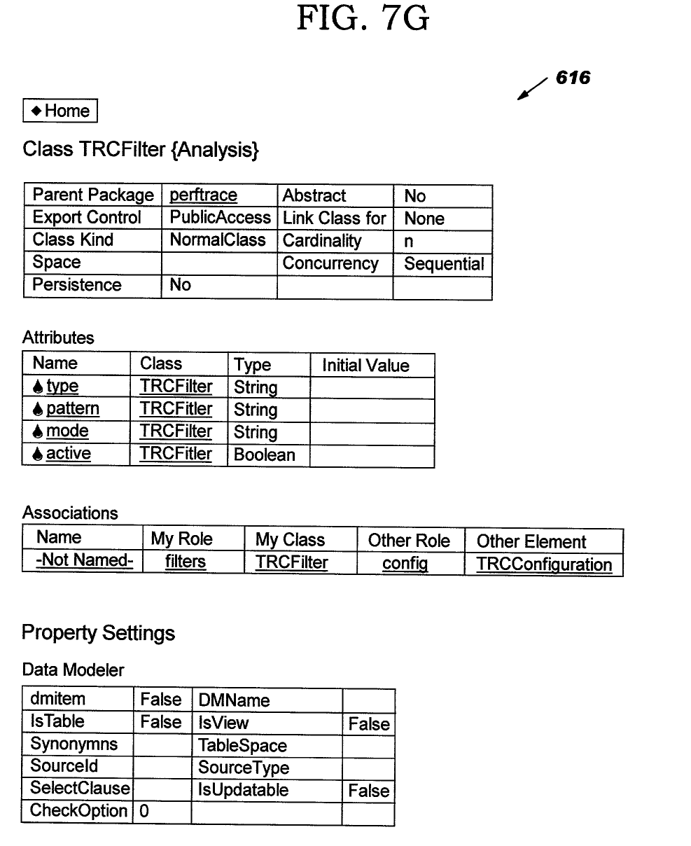

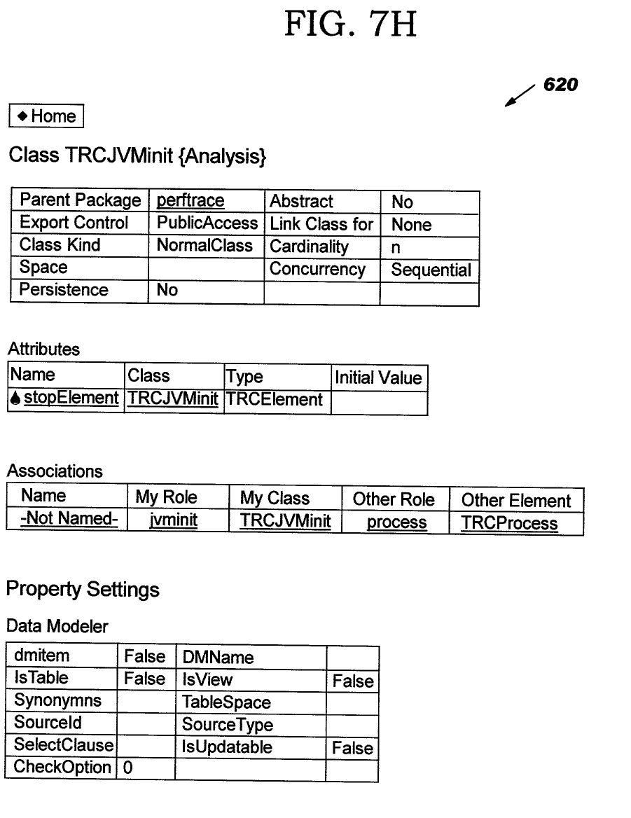

A second exemplary object of object model 314 is illustrated as Monitor class object 600 (FIG. 6A). Monitor object 600 includes ten objects: TRCMonitor object 602; TRCNode object 604; TRCAgent object 606; TRCProcessProxy object 608; TRCProcess object 504; TRCConfiguration object 612; TRCOptions object 614; TRCFilter object 616; TRCMethodlnvocation object 506 and TRCJVMInit object 620. Monitor class object 600 is the logical root for object model 314. The objects 602-620 are illustrated through tables in FIGS. 7A-7H.

A description of each of the objects included in Monitor object class 600 is included in FIGS. 6C-6J and FIGS. 5C and 5D for objects 504, 506, respectively.

Similar to Process object 500, Monitor object 600 (or a description thereof) is stored in database 310 and retrieved by event logger 308 when analysis of development application 306 is required.

Instances of Monitor object 600 are created when events modeled by Monitor object 600 are identified by event logger 308. As with Process object 500, when an event is identified by event logger 308, an instance of one or more of the objects of Monitor object 600 is created and populated with data describing the event. The populated objects (or descriptions thereof) are then stored by event logger 308 in database 310 (as described above).

Of particular note, is TRCNode object 604. TRCNode object 604 models a machine (i.e., a computer system), or at least a machine execution partition. A node owns processes that are tracked. Instances of TRCNode object 604 are populated with data that assists in the analysis of distributed developments applications (described in greater detail below with reference to FIGS. 8-11).

As will be appreciated, Process and Monitor objects 500 and 600, respectively, are only two exemplary object classes. Other object classes which model, for example, execution, memory management and other behaviors could also be included depending upon the factors enumerated above.

Referencing FIG. 8, an exemplary distributed computing environment 800 is illustrated comprising a plurality of computer systems 100 (two computer systems are illustrated in the exemplary embodiment—computer systems 100A and 100B).

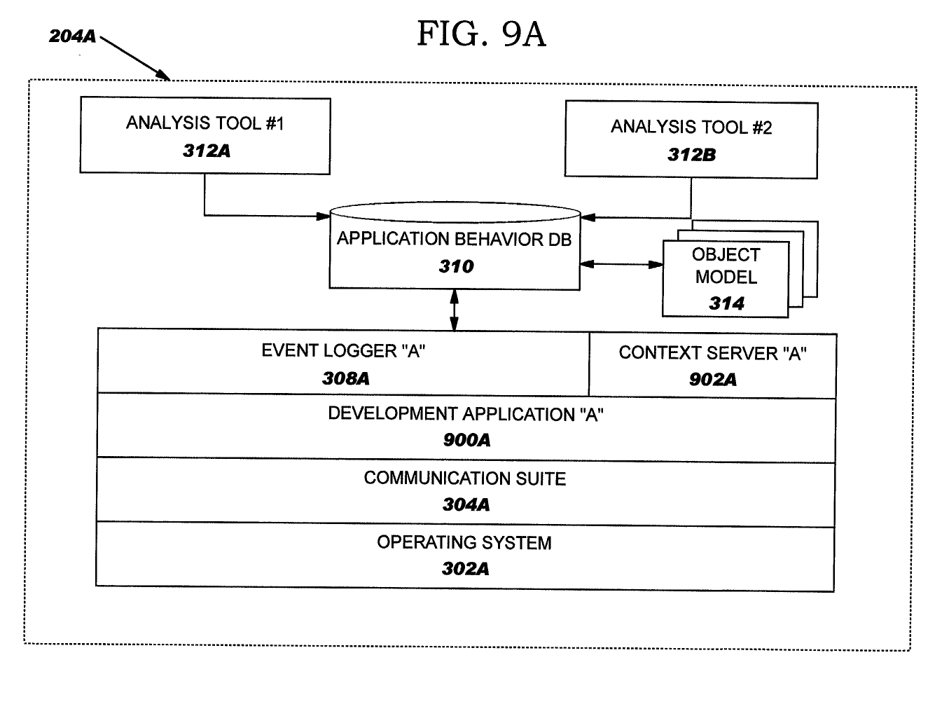

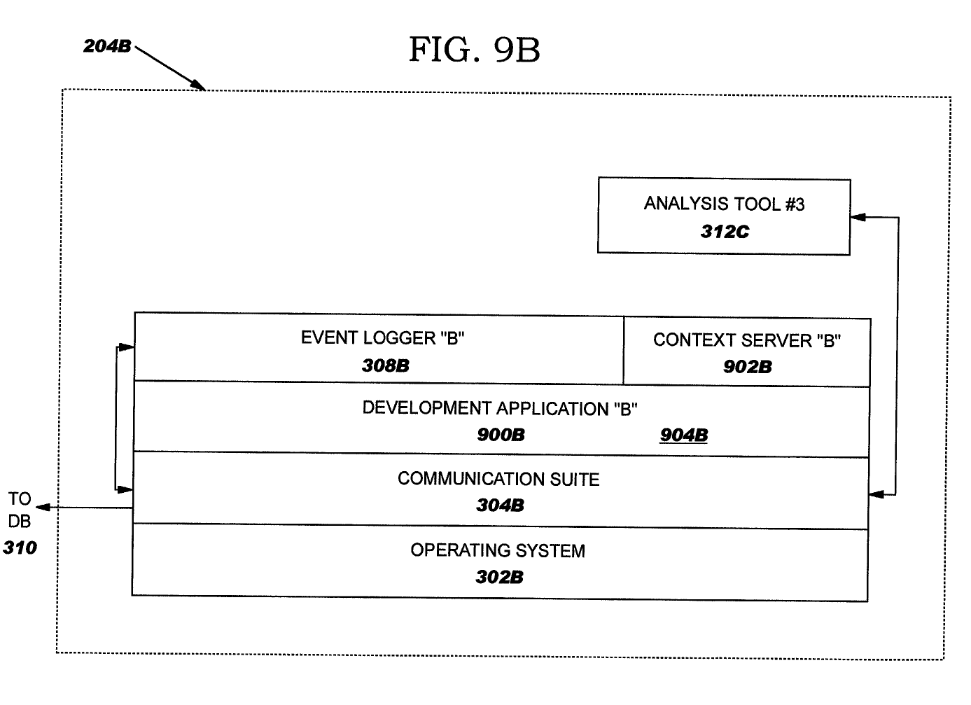

Memory 204A of computer system 100A is illustrated in FIG. 9A and memory 204B of computer 100B is illustrated in FIG. 9B.

Memory 204A (FIG. 9A) is very similar to memory 204 of computer system 100 (illustrated in FIG. 3). As before, memory 204A includes OS 302A, communications suite 304A, and event logger 308A, application behavior database 310 and analysis tools 312A and 312B. Database 310 stores object model 314 (or a description thereof). However, unlike memory 204, memory 204A includes context server 902A and, through operation of communications suite 304A, allows communication between database 310 and other networked devices (e.g., computer system 100B). Additionally, memory 204A includes development application 900A.

Development application 900A, although similar to application 306, forms part of a distributed application (i.e., an application in which a first portion (e.g., application 900A) is executed on a first system such as computer system 100A and a second portion (e.g., application 900B) is executed on a second system such as computer system 100B).

Context server 902A operates to identify the causes and source of requests to invoke a process or agent on the system on which the context server operates. Context server 902A requires the execution of a counterpart context server to also be executed on the computer system of the invoking process to provide the desired functionality. That is, to provide context functionality, a context server is executed on the invoking computer system (e.g., computer system 100B) and the computer system in which the process was invoked (e.g., computer system 100A). Through execution of a context server on both computer systems 100A and 100B, a process invoked on computer system 100A by a process on computer system 100B results in event logger 308A being enabled to identify the process invoked and the identity of the computer system causing the invocation. This context data is stored in instances of TRCNode object 604 (FIG. 6A) which is described above. Context server may be embodied through use of the Context Management Service tool available from IBM. Context server technology is described in Canadian patent application 2,205,096 entitled “A System for Remote Debugging of Client/Server Applications” filed May 9, 1997 and laid open Nov. 9, 1998, and U.S. Pat. No. 5,604,851 issued to Taylor on Feb. 18, 1997 entitled “Method and Apparatus for Constructing Displays of Partially Ordered Data”, the contents of each of which are hereby incorporated herein by reference.

Communication between database 310 and computer system 100B, through operation of communications suite 314A and its counterpart in computer system 100B (described below), may include requests to: retrieve object model 314; create instances of objects forming portions of object model 314; store populated instances of objects forming portions of object model 314; and retrieve populated instances of objects forming portions of object model 314.

Memory 204B of computer system 100B is illustrated in FIG. 9B. Similar to memory 204A, memory 204B includes an OS 302B, a communications suite 304B, a portion of a distributed application (i.e., development application 900B), an event logger 308B, a context server 902B and an analysis tool 312C.

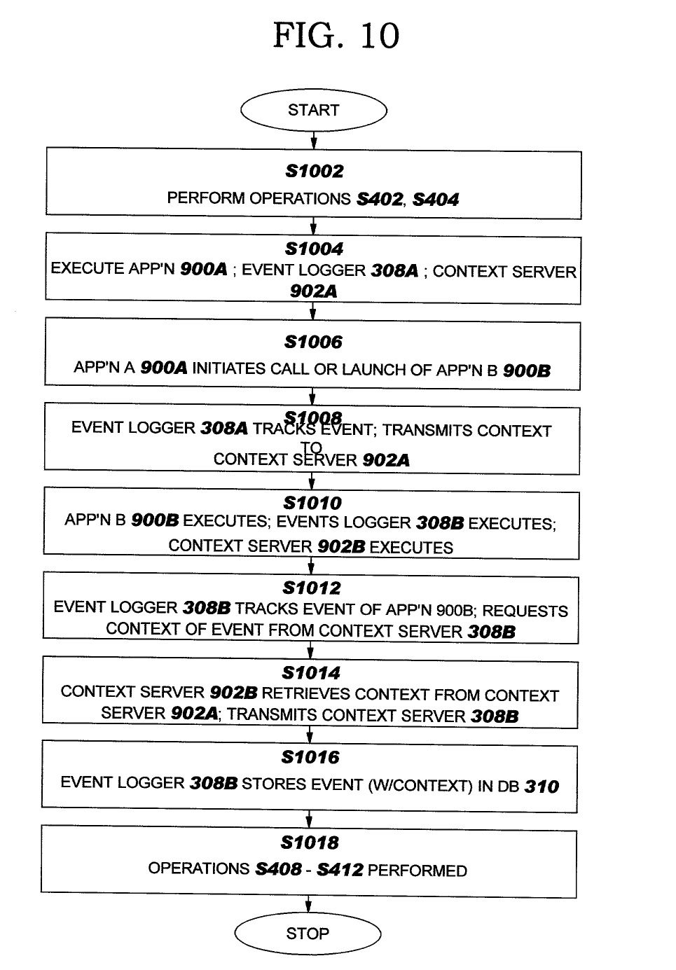

Operations and interaction between computer systems 100A and 100B is best understood with reference to the flowchart FIG. 10 illustrating operations 1000. In the exemplary operations, a first application (application 900A) is executed on a first computer system (computer system 100A) which, during execution, launches a second application (application 900B) on a second computer system (computer system 100B). Communication between applications 900A and 900B is provided over network 110 through operation of respective network I/Fs 210 and communication suites 304A, 304B.

As with operations 400 (FIG. 4), a model of the development application (which, in this instance is a distributed application) is created as object model 314 and stored database 310 (S1002). In S1004, application 900A, event logger 308A and context server 902A are executed. As will be appreciated by those of ordinary skill in the art, event logger 308A and context server 902A should, in most instances, be executed prior to execution of application 900A to ensure tracking of the complete behavior of application 900A. As a result of the execution of application 900A, event logger 308A will have tracked this behavior, created instances of objects in object model 314, populated these instances and stored this data in database 310. One of the objects which may be populated is TRCNode object 604 (FIG. 6A) which includes fields which identify the name and network address (e.g., network address) of computer system 100A.

As described above, in the exemplary embodiment, application 900A launches an application or process on computer system 100B. When application 900A initiates the launch of application 900B (S1006), event logger 308A tracks this behavior (thus storing data describing the behavior in database 310) and also transmits context relating to this behavior to context server 902A. The context in this example is the initiation of the launch of application 900B on computer system 100B by application 900A on computer system 100A (S1008). Responsive to the initiation of the launch of application 900B, event logger 308B and context server 902B are executed, and, preferably, thereafter application 900B is executed (S1010).

Resulting from the execution of application 900B, event logger 308 will create an instance (or instances) of object(s) of object model 314 and populate these objects with data describing the launch and other behaviors.

One object that may be populated is TRCNode object 604 (FIG. 6A) which is used to identify the system on which a process (e.g., application 900B) is executing and additionally the context of its execution (e.g., the process that launched application 900B). This data is collected by event logger 308B by requesting context data from context server 902B (S1012). Context server 902B, responsive to this request, retrieves the necessary context data from context server 902A (via network 110) and provides the retrieved context data to event logger 308B (S1014).

As a consequence, event logger 308B can populate a data object which describes both the event (the launching of application 900B), the location of the event (computer system 100B) and the cause of the event (application 900B launched by application 900A of computer system 100A). The populated data object(s) are then stored in database 310 on computer system 100A by event logger 308B (S1016) via network 110 using, for example, conventional distributed database tools and procedures.

As a consequence of operations S1006-S1016, instances of objects of object model 314 are able to provide data relating to the operation of a distributed application. Analysis tools 314 (regardless of their physical location, i.e., local or remote to database 310) are then able to retrieve behavior data from database 310 and provide analysis on the behavior of a distributed application comprising applications 900A, 900B (S1018). This advantageous ability to track and analyze the behavior of a distributed application has, to the inventors' knowledge, not been provided as simply or as effectively by previous behavior analysis tools.

The embodiments of the invention described herein describe the operation of the application behavior analysis tools occurring after the completion of the operation of event loggers to track data generating by an development application, those of ordinary skill in the art will appreciate that it may be desirable in some embodiments of the present invention to have one or more behavior analysis tools operating in parallel with one or more event loggers. This alternative embodiment may be preferred in complex multi-user systems which often require significant time to generate data that is reflective of a large portion of the behaviors which may be displayed by the development application.

While one (or more) embodiment(s) of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto.

The embodiments of the invention in which an exclusive property or privilege is claimed are defined as follows;

1. A computer system providing application analysis comprising:
a database for storing data; and
an event logger storing data corresponding to behavior of an executing application in said database,
wherein, responsive to a request received from a first application analysis tool, said database transmitting a first portion of said data stored in said database to said first application analysis tool, and wherein, responsive to a request received from a second application analysis tool, said database transmitting a second portion of said data stored in said database to said second application analysis tool.

2. The computer system of claim 1, wherein said database comprises structures representative of behaviors displayed by said executing application and wherein said data stored by said event logger is stored in said structures.

3. The computer system of claim 2, wherein said structures comprise an object model modeling behaviors of said executing application and wherein said data stored in said structures comprises populated instances of said object model.

4. The computer system of claim 3, wherein said object model is created using the Unified Modeling Language.

5. The computer system of claim 1, further comprising a plurality of application tools, each of said plurality of application tools adapted to transmit requests for receive data to said database and receive data from said database.

6. The computer system of claim 5, wherein at least one of said database, said event logger and at least one of said first and second of application analysis tools is distributed across a network.

7. The computer system of claim 1, further comprising:
a network interface providing communications between said computer system and a networked computing system,
wherein said executing application comprises a first executing portion executing on said computer system and a second executing portion executing on said networked computing system, and
wherein said event logger stores data in said database corresponding to behavior of said first executing portion, and
wherein, responsive to data received by said computer system via said network interface, said database stores data corresponding to behavior of said second executing portion.

8. The computer system of claim 7, wherein said event logger stores data describing the system on which said first or said second executing portions are executing.

9. The computer system of claim 1, wherein said data stored further comprises context corresponding to at least one of said first portion and said second portion.

10. The computer system of claim 1, wherein a plurality of application analysis tools reside on one or more of said computer system and said networked computing system.

11. A method for analyzing the behavior of an application, comprising the steps of:
storing behavior data corresponding to behavior of said application exhibited during execution in a database;
analyzing a first portion of said behavior data stored in said database with a first analysis tool; and
analyzing a second portion of said behavior data stored in said database with a second analysis tool.

12. The method of claim 11, wherein said first portion and said second portion of said behavior data are identical.

13. The method of claim 12, wherein said stored behavior data forms a model of the behavior of said application.

14. The method of claim 13, further comprising the steps of:
prior to said storing behavior data stop, collecting said behavior data.

15. The method of claim 12, wherein said storing step further comprises storing said behavior data in a Structured Query Language (SQL) database.

16. The method of claim 12, wherein said storing step further comprises storing said behavior data in instances of objects, said objects forming an object oriented model of said behavior of said application.

17. The method of claim 11, wherein said application comprises a first portion for execution on a first computer system and a second portion for execution on a second computer system and wherein said behavior data comprises context data describing said first computer system and said second computer system.

18. A database for storing behavior data describing behavior of an application, said database comprising:
a receiver receiving data requests, said data requests comprising at least one of: a data request to store behavior data describing behavior of an application and a request for behavior data stored by said database, wherein behavior data forming part of a data request to store behavior data is stored by said database, and wherein said receiver is adapted to receive data requests for behavior data from a plurality of analysis tools, said data requests further comprising a request for behavior data stored by said database; and
a transmitter, said transmitter, responsive to a data request comprising a request for behavior data, transmitting said requested data.

19. The database of claim 18, wherein said behavior data comprises context data.

20. The database of claim 18, wherein said application is distributed between a first computer system and a second computer system and wherein said behavior data comprises context data identifying said first computer system and said second computer system.

21. The database of claim 18 further comprising:
a data structure for storing behavior data of an application, said data structure modeling behavior of said application.

22. The database of claim 21, wherein said data structure comprises an object oriented model of said behavior of said application, said object oriented model comprising an object.

23. The database of claim 22, wherein behavior stored by said database comprises an instance of an object forming part of said object oriented model.

24. The database of claim 21, wherein said data requests comprise Structure Query Language (SQL) compliant requests.

25. The database of claim 21, wherein said transmitter is adapted to transmit said requested data to a plurality of analysis tools.

26. The database of claim 21, wherein data requests to store behavior data are received from a plurality of event loggers.

27. A computer readable media storing computer readable instructions and data, said instructions and data adapting a computer system to:
store behavior data corresponding to behavior describing execution of an application in a database;
analyze a first portion of said behavior data stored in said database using a first analysis tool; and
analyze a second portion of said behavior data stored in said database using a second analysis tool.

28. The computer readable media of claim 27, wherein said first portion and said second portion of said behavior data are identical.

29. The computer readable media of claim 28, wherein said computer system is adapted to store said behavior in a model of the behavior of said application.

30. The computer readable media of claim 29, wherein said computer readable instructions and data further adapts said computer system to:
prior to storing behavior data, collect said behavior data.

31. The computer readable media of claim 28, wherein said storing comprises storing said behavior data in a Structured Query Language (SQL) database.

32. The computer readable media of claim 28, wherein said storing comprises storing said behavior data in instances of objects, said objects forming an object oriented model of said behavior of said application.

33. The computer readable media of claim 28, wherein said application comprises a first portion for execution on a first computer system and a second portion for execution on a second computer system and wherein said behavior data comprises context data describing said first computer system and said second computer system.
